(19) United States
(12) Patent Application Publication
(10) Pub. No.: US 2005/0011365 A1
(43) Pub. Date: Jan. 20, 2005

(54) System for transmitting additional information via a network

(76) Inventors: Catherine Lamy, Paris (FR); Sandrine Merigeault, Suresnes (FR); Lisa Meilhac, Le Cannet (FR)

Correspondence Address: Philips Electronics North America Corporation;Corporate Patent Counsel, PO Box 3001, Briarcliff Manor, NY, 10510, US

(21) Appl. No.: 10/498,133

(22) PCT Filed: Dec. 6, 2002
(86) PCT No.: PCT/IB02/05242

(30) Foreign Application Priority Data
Dec. 11, 2001 (EP) 01403197.5
Apr. 16, 2002 (EP) 02290950.1

(51) Int. Cl. A23L 1/00

(52) U.S. Cl. 99/326

(57) ABSTRACT

The present invention relates to a transmission system for transmitting source application data units to a destination application via a network comprising a plurality of network protocol stacks. Such a transmission system provides a solution for transmitting additional information from a layer of a first network protocol stack to a layer of a second network protocol stack, without disturbing the way in which ordinary streams are processed. To this end, it further comprises: generating means for generating additional information at a layer of a first network protocol stack to be sent to a layer of a second network protocol stack via at least said first and second network protocol stacks, adapting means for converting said additional information into at least one additional data unit compliant with network protocol rules, marking means for marking said additional data units, retrieving means for retrieving said additional information within said additional data units when said additional data units arrive at said layer of said second network protocol stack. More generally, the invention deals with all the possible exchanges of additional information between layers of network protocol stacks within a transmission system. Said transmission system may also include some routers.

### FIELD OF THE INVENTION

The present invention relates to a transmission system for transmitting source application data units to a destination application via a network comprising a plurality of network protocol stacks.

The invention also relates to a method of transmitting data units, which method is intended to be used in such a transmission system.

The invention also relates to a receiver comprising a destination network protocol stack and a destination application for processing source application data units transmitted to said destination application via a network.

The invention also relates to a transmitter comprising a source application and a source network protocol stack for processing source application data units to be transmitted over a network.

The invention further relates to a program for implementing such a method.

The invention is especially useful for applications where transmission of multimedia content via band-limited and error-prone networks like wireless networks is involved.

### BACKGROUND OF THE INVENTION

In the domain of digital communications, applications are connected by networks. A commonly used network architecture is the seven-layer ISO reference model described in the book entitled “Computer Networks” written by Andrew Tanenbaum, in the collection “Prentice Hall”, edited by Dunod, from pages 14 to 21. According to this model, a network is organized in layers, which are ruled by protocols. All the operations of network management are performed by a network protocol stack, which plays the role of an interface between applications and transmission channels. Network protocol stacks are therefore placed at both sides of a transmission channel.

The first layer, called physical layer, comprises a transmission channel, which handles the physical transmission of data. Upper layers are in charge of applying the network protocols, that is to handle operations related to data transmission like routing, addressing, error checking, etc. The last layer, called application layer, manages user interface to network and is concerned with the requirements of the destination application.

In the classical scheme of a transmission system shown in FIG. 1, the source application SAPP is included in a transmitter TRANS, which comprises a source network protocol stack SSTK, whereas the destination application DAPP belongs to a receiver REC, which comprises a destination network protocol stack DSTK. As defined by the OSI reference model, said source network protocol stack SSTK and said destination network protocol stack DSTK, respectively comprise seven layers Lᵢ with i from 1 to 7:
L₁: the physical layer,
L₂: the data link layer,
L₃: the network layer,
L₄: the transport layer,
L₅: the session layer,
L₆: the presentation layer and
L₇: the application layer.

Input data ID are first processed by the source application SAPP, which supplies source application information SAI. Said source application information is then converted by the source network protocol stack SSTK into transmitted source application data units TSADU, which are sent to the receiver REC via the network. Received source application data units RSADU are received by the destination network protocol stack DSTK, which extracts received source application information RSAI from said received source application data units RSADU. Said received source application information RSAI is finally processed by the destination application DAPP, which outputs some output data OD.

As a conclusion, to be transmitted via the network, any information must be compliant with the network protocols.

### SUMMARY OF THE INVENTION

It is an object of the invention to provide a solution for transmitting additional information from a layer of a first network protocol stack to a layer of a second network protocol stack of a transmission system, without disturbing the way in which ordinary streams are processed.

A transmission system according to the invention and as described in the opening paragraph is characterized in that said transmission system further comprises:
generating means for generating additional information at a layer of a first network protocol stack to be sent to a layer of a second network protocol stack via at least said first and second network protocol stacks,
adapting means for converting said additional information into at least one additional data unit compliant with network protocol rules,
marking means for marking said additional data units,
retrieving means for retrieving said additional information within said additional data units when said additional data units arrive at said layer of the second network protocol stack.

The invention deals with all the possible exchanges of information between layers of network protocol stacks within a transmission system. Said information is sent in addition to an ordinary data stream transmitted from a source application to a destination application. It is generated by a first layer of a first network protocol stack and addressed to a second layer of a second network protocol stack, which could be the same as the first network protocol stack. Said information is therefore called additional information. Said additional information is for instance channel state information output at the receiver side by the physical layer and useful for the destination application. Some additional information may also be exchanged within the transmitter, for instance from application to physical layers if it concerns the level of importance of a set of data of an ordinary stream. This kind of information may help the channel encoder to decide which protection level is to be applied to the set of data.

Some additional information may also be sent from the receiver to the transmitter and vice-versa. For instance, channel state information available at the physical layer of the receiver may also be useful for the source application, especially if said source application outputs scalable data streams. As a matter of fact, if the channel conditions are bad with a high error rate, the source application may decide to send only the basic data stream to the receiver. On the contrary, if channel conditions are satisfactory with a fluid traffic, said source application will possibly supply both basic and enhancement data streams.

It is also to be noted that a network may comprise several transmission channels separated by routers. A router is a network protocol stack used for re-directing data units transmitted through a transmission channel towards a new transmission channel. Routers comprise layers that may also provide additional information to be sent to the destination application at the receiver side.

In a specific embodiment of the invention, if said additional information is associated with a source application data unit, said transmission system further comprises collecting means for collecting information about said source application data unit to be used by said adapting means when converting the additional information associated with said source application data unit into additional data units. The aim is to pick up information within said source application data unit, that, when copied within said additional data units, will indicate that they are related to said source application data unit. This is, for instance, the case with channel state information indicating the error rate at the time when said source application data unit has been received by the destination application. Said channel state information has to be associated with said source application data unit. Said collecting means advantageously give said additional data unit a sequence number, which is equal to that of said source application data unit.

In another embodiment of the invention, if a layer of the destination network protocol stack comprises acknowledgement means for sending acknowledgement messages about said source application data units back to the corresponding layer of another network protocol stack, for instance, at the transmitter side, then the transmission system also provides some deactivation means for deactivating said acknowledgement means for said additional data unit. An advantage of the invention is therefore that the way in which the destination network protocol stack works for ordinary streams is not affected by the transmission of additional data units, especially for quality of service. The aim is basically to avoid any network error due to acknowledgement messages received about data units that the transmitter ignores.

Said marking means advantageously give a specific destination port number to said additional data units.

In a preferred embodiment of the invention, said additional information is soft information associated with a hard decision made on a source application data unit received at the physical layer of the destination network protocol stack of a receiver. Said soft information is addressed to a destination application, for instance a source decoder. Consequently, said transmission system further comprises a channel decoder for supplying said additional information and said adapting means further comprise:
quantification sub-means for supplying shorter additional information from said additional information,
discrimination sub-means for discriminating useful information and control information in said shorter additional information,
structuring sub-means for structuring said useful information into useful fields,
encapsulation sub-means for encapsulating said useful fields into said additional data units compliant with said network protocol stack, by using said control information.
   Said retrieving means further comprise:
destination de-quantification sub-means for recovering said additional information from said useful fields.

Said transmission system of course comprises collecting means, because said additional information directly derives from a received source application data unit.

In this preferred embodiment of the invention, it is of great interest to transmit said soft information to the destination application, because it has been proved that it allows improving its performances.

In addition, there is provided a method intended to be utilised by a transmission system according to the invention.

### BRIEF DESCRIPTION OF THE DRAWINGS

Additional objects, features and advantages of the invention will become apparent upon reading the following detailed description and upon reference to the accompanying drawings in which:

FIG. 1 is a schematic diagram of a networked communication system according to the prior art,

FIG. 2 is a schematic diagram giving some examples of additional data exchanges within a transmission system,

FIG. 3 is a schematic diagram of a receiver according to the invention,

FIG. 4a depicts the structure of a data unit compliant with network protocol rules,

FIG. 4b shows the layered structure of a network protocol stack according to the OSI model,

FIG. 4c shows the layered structure of a network protocol stack according to the TCP/IP model,

FIG. 5 is a schematic diagram illustrating the transmission of additional soft data units within a transmission system according to the invention,

FIG. 6a depicts the adapting means of a transmission system according to the invention,

FIG. 6b depicts the retrieving means of a transmission system according to the invention,

FIG. 7 is a schematic diagram of a uniform quantification that may be used for soft decoding within the quantification sub-means according to the invention,

FIG. 8 depicts the discrimination sub-means according to the invention,

FIG. 9 depicts both the structuring and encapsulation sub-means according to the invention,

FIG. 10 is a schematic diagram illustrating the transmission of additional soft data units within a transmission system including several routers,

FIG. 11 is a schematic diagram for the transmission of a controlling order or additional information in the “iterated” soft decoding mode from the application layer to the physical layer within a receiver according to the invention,

FIG. 12a depicts the adapting means for the “iterated” soft decoding mode according to the invention,

FIG. 12b depicts the retrieving means for the “iterated” soft decoding mode according to the invention.

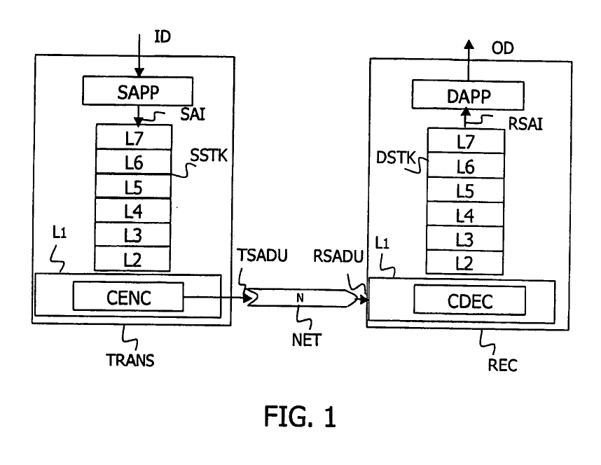

### DETAILED DESCRIPTION OF THE INVENTION

The present invention relates to a transmission system for transmitting source application data units to a destination application via a network comprising a plurality of network protocol stacks.

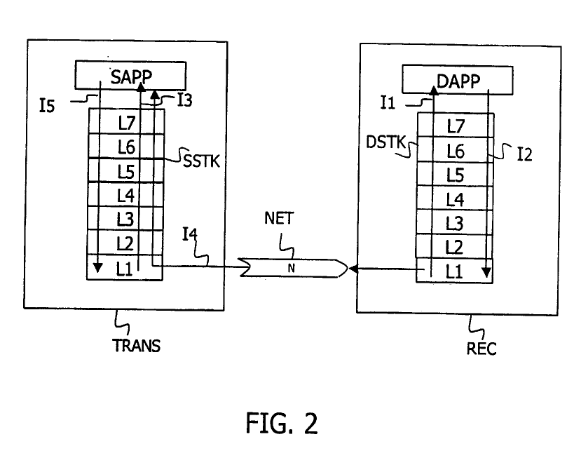

Such a transmission system allows transmission of additional information from any layer of a first network protocol stack to any other layer of a second destination network protocol stack. A classical transmission system comprising a transmitter TRANS, a network NET and a receiver REC is represented in FIG. 2. Said transmitter TRANS comprises a source application SAPP and a source network protocol stack SSTK and said receiver REC comprises a destination network protocol stack DSTK and a destination application DAPP. Said transmitter and receiver are connected by said network NET. Five examples of additional information (Iᵢ) are given:
additional information I₁ is transmitted from the physical layer to the application layer of the destination network protocol stack. It could be channel state information associated with source application data units, which could help a destination application to make more appropriate decisions for processing said source application data units,
additional information I₂ is sent by the application layer to the physical layer of the destination network protocol stack. It could be a controlling order to ask the channel decoder of said physical layer to start or stop soft decoding.
additional information I₃ is transmitted from the physical layer to the application layer of the source network protocol stack. It could be for instance channel state information, which could help the source application to make some decisions about the way input data have to be encoded,
additional information I₄ is sent by the physical layer of the destination network protocol stack to the application layer of the source network protocol stack. It could be channel state information measured at a time, which may, in case of a scalable encoding approach, help the source application to decide if it will send only the basic data stream or both basic and enhancement streams,
additional information I₅ is sent by the application layer to the physical layer of the destination network protocol stack. It could be a level of importance associated with a source application data unit, which could help the physical layer to choose an adapted level of data protection for said source application data unit.

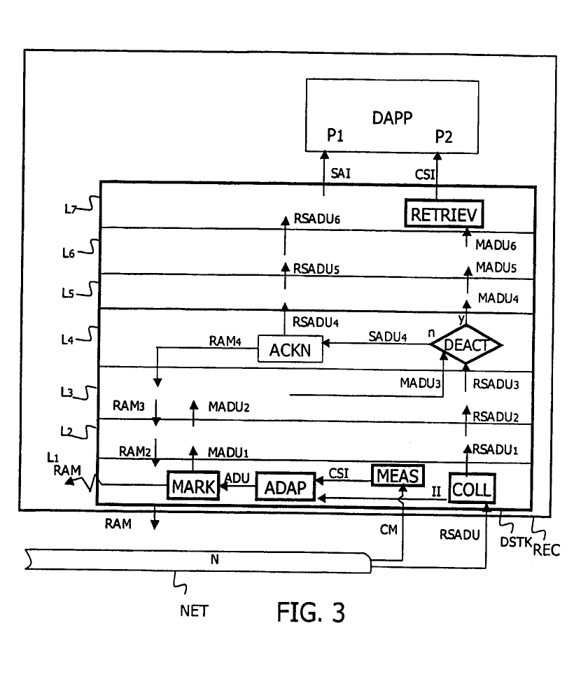

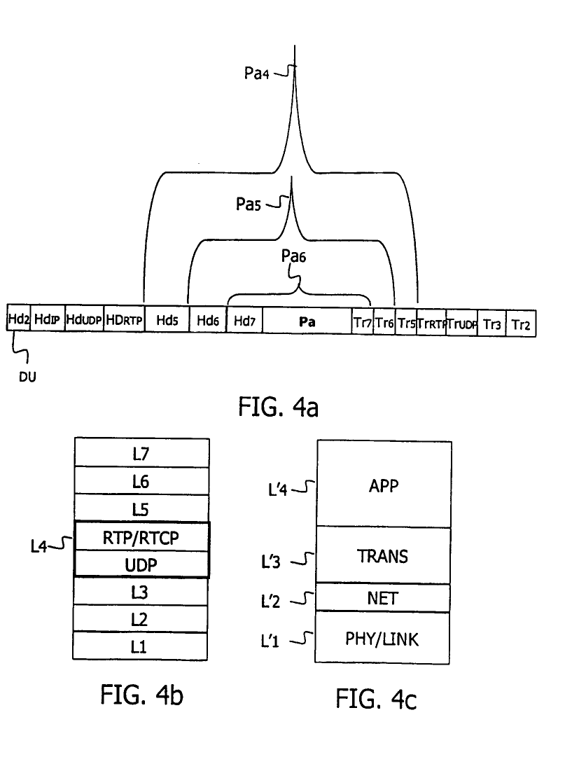

A first embodiment of the invention is described in FIG. 3. It deals with additional information 11. A receiver REC of a transmission system comprises a destination network protocol stack DSTK and a destination application DAPP, which is, for instance, a source decoder. Said destination network protocol stack DSTK is developed in layers according to the OSI reference model, shown in FIG. 4b, which is well known to those skilled in the art.

It is to be noted that said model is not the only one. The TCP/IP reference model, shown in FIG. 4b, is also very widely used, but only comprises four layers. Its first layer L′₁ groups L₁ and L₂, L′₂ corresponds to the network layer L₃, L′₃ corresponds to the transport layer L₄ and L′₄ groups L₅, L₆ and L₇.

Source application data units RSADU are received through the network NET by the physical layer L₁ of the network protocol stack DSTK. Said physical layer achieves several operations on said received data source application data units RSADU like demodulation, equalization and channel decoding. It may also comprise generating means, for instance measurement means MEAS for supplying channel state information CSI from measurements CM on the channel.

Channel state information CSI helps upper layers of the destination network protocol stack to choose an appropriate strategy for better processing the received source application data units. It is therefore of great interest to propagate this kind of information upwards. Said Channel State Information CSI is a kind of additional information produced by the physical layer of the destination network protocol stack. The receiver therefore comprises adapting means ADAP for converting said additional information CSI into an additional data unit compliant with network protocol rules. In the example of FIG. 3, said adapting means ADAP belong to the physical layer L₁ because the additional information is provided at this stage. If said additional information was provided by another layer, said adapting means would belong to that other layer.

The goal of the adapting means ADAP is to supply an additional data unit ADU, which both:
includes the channel state information CSI,
is compliant with the destination network protocol stack DSTK.

A data unit compliant with the destination network protocol stack DSTK has a specific structure, as shown in FIG. 4a. Said structure is divided into two types of information, which is useful information, also called payload, and control information. The useful information is the information to transmit, in the present case channel state information CSI. The control information gathers all the data used by the successive layers of the network protocol stack DSTK to handle said data unit, for instance to check its validity. There are in fact two types of control information, some headers Hdᵢ and some trailers Trᵢ, with i from 2 to 7, which are appended by the corresponding layer Lᵢ within the transmitter at the beginning and at the end of the useful information. Said headers and trailers are removed within the receiver, when the data unit passes upwards through the network protocol stack DSTK. It should be noted that all the layers but the physical layer L₁ have an associated header and possibly a trailer. At the physical layer, the notion of data unit, also called a frame, is still meaningless, because data are only considered as a succession of bits.

Therefore, the adapting means ADAP have to create an additional data unit ADU, which is interpretable by the next layer, that is the data link layer L₂.

It is to be noted that, as shown in FIG. 4a, the content of the so-called payload changes with layers: let us call Pa the useful information to be sent to the destination application DAPP, Pa is the payload of layer L₇, but the payload Pa₆ of layer L₆ further comprises the header Hd₇ and trailer Tr₇ of upper layer L₇, and so on.

A way of building a compliant additional data unit ADU for the channel state information CSI is to copy the control information of a previously received source application data unit, that is its headers and trailers, at the beginning and at the end of the useful information CSI (said control information has, for instance, been stored in a memory). Within the headers and trailers, said control information contains several fields and among them:
the IP address, which defines a receiver (for instance, a computer) destination address for the current data unit. It belongs to the network layer L₃,
the UDP length, which defines the total length of the UDP header concatenated to the UDP payload. It belongs to the transport layer L₄,
the UDP checksum, which is the sum made by the bits of the UDP header concatenated to the UDP payload. It also belongs to the transport layer L₄,
the destination port number, which specifies a destination application or process. It also belongs to the transport layer L₄,
the RTP sequence number, which identifies and numbers the data unit within a data stream. It also belongs to the transport layer L₄.

Since some of these fields strongly depend on the characteristics of the useful information stored in the payload, they have to be especially recalculated for the additional data unit ADU. For instance, the UDP length needs to be recalculated, because the useful information is not the same as in the originally received data unit. Consequently, the UDP checksum also needs to be updated.

Moreover, since the transmission conditions often fluctuate, Channel State Information CSI is a varying measure, which only holds for a certain period of time. Consequently, it may be associated with a moment or with a source application data unit, which arrived at the physical layer at this moment. In the case of a moment, an additional field called “time stamp” may be used to limit the validity of said channel state information. Such a field starts with a given positive value and decrements until zero. In the case of a source application data unit, it is necessary to pick up identifying information within said source application data unit, which will serve at the destination layer for indicating that said channel state information is only valid for said source application data unit.

To this end, the transmission system according to the invention further comprises collecting means COLL for collecting identifying information II about a received source application data unit RSADU, said identifying information being used by said adapting means when converting the additional information associated with said source application data unit into an additional data unit ADU.

Therefore, said collecting means reproduce in parallel the operations of de-capsulation performed by the network protocol stack DSTK for transmitting said source application data unit upwards from the physical layer to the application layer, apart from the fact that they stop when said identifying information II has been reached. Said identifying information may be for instance the RTP sequence number stored in the RTP header of the received source application data unit RSADU. Said RTP sequence number is then supplied to the adapting means ADAP so as to be further included in the additional data unit ADU.

It is to be noted that, if the additional information to be transmitted from a layer of a first network protocol stack to a layer of a second network protocol stack is not related to a specific source application data unit, said collecting means are useless and said adapting means then give a meaningless value to the RTP sequence number, for instance zero.

Once all the concerned fields of headers and trailers have been re-calculated, the additional data unit ADU is supplied to marking means MARK. Said marking means MARK are intended to differentiate said additional data unit ADU from the received source application data units RSADU by supplying a marked additional data unit MADU₁. Such a differentiation is, for instance, very useful at the second layer, because most of the time the marked additional data units MADU are not intended to be processed in the same way as the received source application data units RSADU.

Such a marking operation is advantageously achieved by affecting a specific destination port number P₂ to the additional data unit ADU, which is different from the one of said received source application data units RSADU (for instance, they have a destination port number P₁). The destination port number is a field, which belongs to the UDP header and is therefore not taken into account by the layers placed below the transport layer L₄.

It should be noted that specific standard applications like the Pile Transfer Protocol (FTP) have their reserved destination port number, which cannot be used by another application. For other applications like, for instance, a source decoder, all the free port numbers are possible, even several destination port numbers for the same application.

The solution of the destination port number is of course not limitative. Another option is to give to the additional data units ADU the same RTP sequence number as the received source application data unit RSADU.

Said marked additional data unit MADU₁ is then sent up to the data link layer L₂. Once it has received said marked additional data unit MADU₁, the data link layer L₂ checks and removes its header Hd₂ and trailer Tr₂ and sends a new version MADU₂ of the marked additional data unit to the network layer L₃. Said network layer L₃ achieves a similar process and supplies its version MADU₃ of the marked additional data unit to the transport layer L₄.

If we suppose that the marked additional data unit MADU₃ has passed the exam of the transport layer L₄, a new version MADU₄ is sent to the upper layer. The process goes on until the application layer L₇, where a version MADU₆ of said marked additional data unit is presented to retrieving means RETRIEV for retrieving the additional information, for instance channel state information CSI, within said marked additional data unit. Another objective of said retrieving means RETRIEV is to direct said additional information to the right destination port number and, if needed, to bring it together with the source application information SAI contained within the received source application data unit RSADU₆ it is associated with. Afterwards, said additional information reaches its destination application DAPP.

As we will further see, depending on the layer to which the additional information is addressed, said retrieving means may perform more complicated operations.

An advantage of having said channel state information CSI available at the application level is really valuable. As a matter of fact, such relevant information may help to make strategic choices: for instance, depending on the channel state, a source decoder receiving scalable streams of data may ask the transmitter to send only a basic stream if the channel error rate is high or ask for more, that is the basic and the enhancement streams if there are good transmission conditions.

Before going on, the way in which the transport layer L₄ works must be studied in more detail. It is either ruled by a single reliable protocol, called TCP or by two protocols, the UDP protocol providing a best effort service, coupled, as shown in FIG. 4b, with a reliable protocol, for instance RTP/RTCP. A common characteristic for all the reliable protocols is that they comprise, at the receiver side, some acknowledgement means ACKN providing a quality of service. Said acknowledgement means are intended to send acknowledgement messages back to the transmitter to inform it about how many valid data units it has received. Depending on the protocol used, the frequency of said acknowledgement messages may vary. For instance, the protocol TCP sends an acknowledgement message for each valid data unit received, which heavily overloads the transmission channel. It even induces a delay, which is totally incompatible with real-time applications. The RTP/RTCP protocol realizes a better compromise between reliability and cost efficiency, because it only sends a single acknowledgement message for several data units received on a same destination port number. Consequently, the choice between the TCP and UDP/RTP/RTCP protocols depends on the application.

With these acknowledgement messages, the transmitter deduces which data units have not yet been received by the receiver and may decide to retransmit them.

At the receiver side, the acknowledgement means ACKN may also decide to wait for retransmission or to directly ask for immediate retransmission.

The transport layer L₄ is also in charge of identifying the destination application DAPP to which the marked additional data unit is addressed.

For a received source application data unit SADU₄, the acknowledgment means ACKN output an acknowledgement message RAM₄ to be sent to the transmitter. Said acknowledgement message RAM₄ has to pass downwards through the lower layers, from network to data link layers as an acknowledgement message RAM₃, from the data link to physical layers as an acknowledgement message RAM₂ and from physical layer to transmission channel as an acknowledgement message RAM. It is then transmitted via the transmission channel of the network NET and received by the transmitter TRANS. It is to be noted that such a process of acknowledgement by the TCP or the RTP/RTCP protocol is systematic, in other words, it is applied to all the data units passing upwards through the transport layer.

However, it may happen that the transmitter ignores the existence of an additional data unit. For instance the transmitter ignores the existence of the additional data unit ADU that contains the channel state information CSI. Consequently, the reception of an acknowledgement message for such an additional data unit ADU will induce some protocol errors at the transmitter side.

To avoid this, a simple solution would be to inhibit the quality of service for all the source application data units at the receiver side by only using the unreliable UDP protocol instead of the TCP or RTP/RTCP protocol in the transport layer. In this case, the use of a second port number by the marking means MARK is not useful at this level, because all the data units are processed in the same way by the transport layer. However, this solution is not satisfying at all, because the possibility to transmit additional information from a first to a second layer is obtained at the expense of the quality of service of the whole received source application data units.

To solve this problem, the transmission system according to the invention further comprises deactivation means DEACT for inhibiting the acknowledgment means ACKN for an additional data unit ADU. Said deactivation means are shown in FIG. 3.

In the first embodiment of the invention, the case where the UDP/RTP/RTCP protocols are used is considered. Said deactivation means DEACT are placed within the physical layer L₁. They exploit the way in which additional data units have been marked by the marling means MARK to recognize them and force them to skip the RTP/RTCP protocol. This is simply done by removing the RTP/RTCP header and trailer. Consequently, the received source application data units RSADU are processed by the UDP protocol followed by the RTP/RTCP protocol, whereas the additional data units ADU, supposed to be unknown from the transport layer of the transmitter, are only processed by the UDP protocol. In other words, quality of service is discarded for the additional data units ADU, but maintained for the received source application data units RSADU.

Another solution is to process all the data units in the same way at the transport layer, that is to let the TCP or UDP/RTP/RTCP protocol send an acknowledgement message for all the data units, but to set up deactivation means DEACT at the physical layer L₁ for stopping the messages corresponding to data units with the specific destination port number P₂. The advantage of this alternative is that it only modifies the physical layer, the only one that is not ruled by protocols.

An advantage of the invention is to make a selective quality of service possible. With the invention, the transmission of additional information from the physical to the application layer is not obtained at the expense of reliability and brings up a real added value.

If the RTP/RTCP protocol is used, it is to be noted that an acknowledgement message is sent back to the transmitter for several valid data units having the same destination port number, i.e. either P₁ or P₂. Consequently, no acknowledgement message will be transmitted about a mix of received source application and additional data units.

It is also to be noted that it is not only the transport layer L₄ that comprises some acknowledgement means. Lower layers like the data link layer L₂, for instance, also comprise specific acknowledgement means. In the preferred embodiment of the invention, these specific acknowledgement means are partially inhibited, in order to prevent them from asking the transmitter for retransmission of a corrupted data unit. As a matter of fact, the destination port number of a data unit is not visible at this stage and therefore additional data units cannot be identified. Consequently, said specific acknowledgement means only check and possibly reject the data units they have received. However, it should be possible to set up a selective quality of service also for these lower layers by marking the additional data units using lower layer control information.

It is finally to be noted that said first layer information is also likely to be useful for a layer higher than the physical layer, like the transport layer L₄. Channel state information CSI could, for instance, help the TCP or the RTP/RTCP protocol to choose the best strategy to adopt for a corrupted data unit:
either asking the transmitter for retransmission, if the error rate is low and the traffic rather fluid,
or trying to correct the corrupted data unit, if the error rate is high or if there are network congestions.

Before continuing, it is stressed that the part of the invention related to acknowledgement is optional and that consequently the invention still exists if this part is discarded.

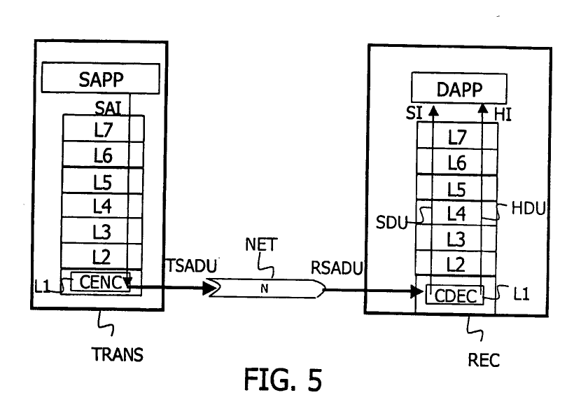

A second embodiment of the invention is described in FIG. 5. It deals with the transmission of hard and soft information HI and SI supplied by a channel decoder CDEC about a received source application data unit RSADU. Said channel decoder CDEC belongs to a physical layer L₁ of a destination network protocol stack at the receiver side of a transmission system. Said hard and soft information HI and SI is addressed to the application layer L₇ of said destination network protocol stack DSTK.

It is to be noted that, as already mentioned above and unlike what is shown in FIG. 5, the physical layer is not restricted to said channel decoder CDEC (or at the transmitter side said channel encoder CENC), but achieves mechanical, functional and electrical interface to the transmission channel of the network N. It comprises, for instance, means related to (de)modulation or equalization.

For each real value of a received source application data unit RSADU transmitted via a network NET, the channel decoder CDEC produces one hard bit, which is the hard decision it has taken about said real value and several soft bits, which stand for a reliability measure to be put on said hard decision. Said reliability measure is very useful for the destination application DAPP to make its own choices about the received source application data unit. The channel decoder outputs hard and soft bits for said received source application data unit RSADU. Said soft bits are a form of additional information, associated with said hard data unit to be transmitted from a first layer (the physical layer) to a second layer (the application layer) of the destination network protocol stack DSTK.

In this second embodiment of the invention, the generating means are therefore provided by the channel decoder CDEC.

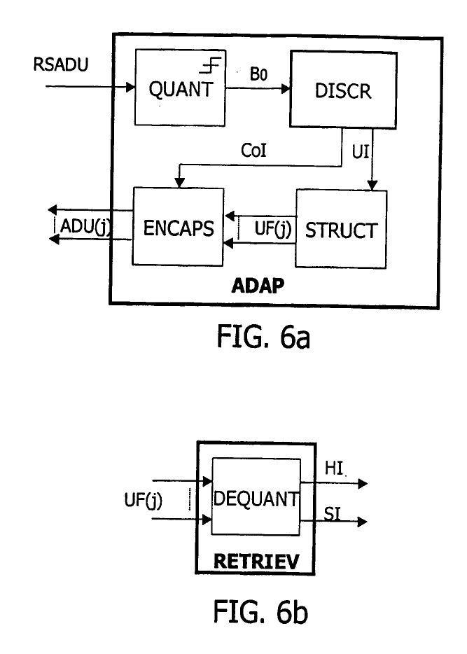

In order to be able to transmit said soft bits, the transmission system according to the invention further comprises:
within the adapting means ADAP, described in FIG. 6a:
quantification sub-means QUANT for supplying shorter additional information B₀ from said additional information HI and SL
discrimination sub-means DISCR for discriminating useful information UI and control information CoI in said shorter additional information B₀, structuring sub-means STRUCT for structuring said useful information UI into useful fields UFO(j) with j from 2 to 7,
encapsulation sub-means ENCAPS for encapsulating said useful fields UF(j) into said additional data units ADU(j) by using said control information CoI,
within the retrieving means RETRIEV:
destination de-quantification sub-means DEQUANT, for recovering said additional information HI and SI from said useful fields UF(j).

The quantification sub-means QUANT are intended to supply shorter additional information B₀ from said additional information HI and SI. This operation is needed for several reasons:
first, before being transmitted via the network NET, a data unit is modulated by the channel encoder CENC, for example using a BPSK modulation, which is well known to those skilled in the art. Said modulation is needed because the obtained modulated data unit will be transmitted via the network NET by a physical signal.
secondly, due to the transmission, each data of the received source application data unit RSADU has a real value, which may not be exactly −1 or 1, as it should be according to the BPSK modulation.
thirdly, at the output of the transmission channel, each data of the received source application data unit RSADU is quantified into a large number of bits in order to provide a binary data sequence of said data nearly without truncation. A quantified received source application data unit is obtained. Each quantified data of said quantified received source application data unit is converted by the channel decoder CDEC into a quantified probability. For instance, in the case of a BPSK modulation, the sign of said quantified probability indicates the more likely final value of said quantified data contained within the received source application data unit RSADU (either −1 or 1) and the module represents the likelihood of this final value to be correct. Such a channel decoder CDEC is called a soft output channel decoder. A hard output channel decoder would directly replace each real value of said received data unit by said most likely final value. Such a hard output channel decoder would generate a kind of hard channel decoded information which is hopefully identical to the transmitted source application data unit TSADU. Consequently, provided there is no transmission error, said hard channel decoded information would be equal to the transmitted source application data unit TSADU and hence would be accepted by the network protocol stack DSTK. In case of a soft output channel decoder however, one transmitted bit is not replaced by one hard bit, but by N soft bits, consisting, for instance, of one hard bit plus N−1 supplementary soft bits. Consequently, the obtained additional information is much longer than the transmitted source application data unit TSADU and would be definitely rejected by the network protocol stack DSTK.

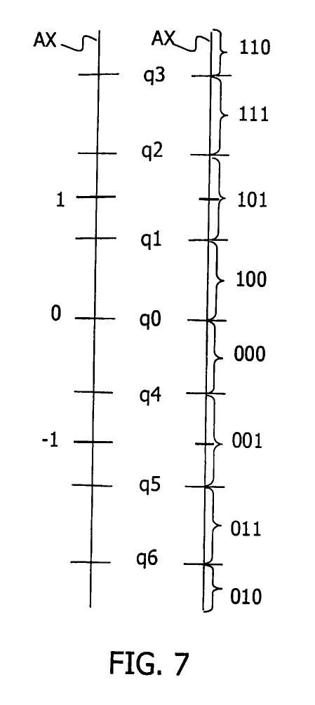

Therefore, said additional information HI and SI is processed by the channel quantification sub-means QUANT, as illustrated in FIG. 6a. For instance, a uniform quantification over N=3 bits is done, as shown in FIG. 7. The level 0 of quantification is defined by a delimiter q₀=0, which is the middle of segment [−1,1] of an axis AX. Then, by symmetry over q₀, six other quantification delimiters q₁, q₂, . . . ,q₆ are defined, which completely partition the axis AX into the following intervals:]−∝, q₆[, [q₆, q₅[, [q₅, q₄[, [q₄, q₀[, [q₀, q₁[, [q₁, q₂[, [q₂, q₃[, [q₃, ∝[, where the possible bit sequences for a received real value of the first layer information are 010, 011, 001, 000, 100, 101, 111 and 110 respectively. Said quantification delimiters could have, for instance, the following values: q₁=0.666=−q₄, q₂=1.334=−q₅ and q₃=2.0=−q₆. The most significant quantified bit is the hard bit or the decision of the channel decoder CDEC about a data of the received source application data unit RSADU. It is to be noted that in traditional decoders where no joint source-channel decoding is performed, a threshold detector is placed behind the channel decoder CDEC and outputs said hard bit. When the quantification sub-means QUANT only output the above-mentioned hard bit, they play the role of a simple threshold detector.

The N−1 other quantified bits are the soft bits, which represent the probability related to said hard bit or decision. The set of N quantified bits is the so-called shorter first layer information.

Finally the quantification sub-means QUANT output shorter additional information, which is organized in a buffer B₀ containing the N quantified bits of every received data of the first layer information, that is control and useful information.

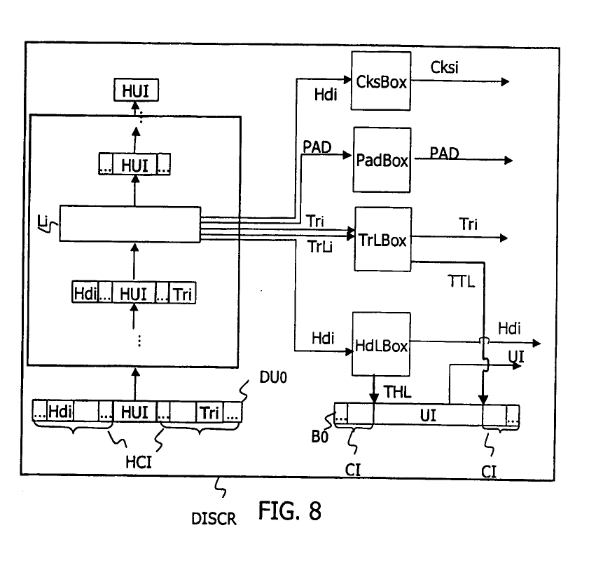

The discrimination sub-means DISCR, shown in FIGS. 6a and 8, are intended to discriminate useful information UI and control information CoI in said shorter additional information B₀. To this end, said discrimination sub-means DISCR first create a hard data unit DU₀ in the following way: DU₀ contains the hard bit of said shorter first layer information B₀. Said hard data unit DU₀ comprises hard control information HCI (headers Hdi and trailers Tri) and hard useful information HUI.

Then, said discrimination sub-means DISCR de-capsulate said hard data unit DU₀ in the same way as a network protocol stack does, that is, for each layer Lᵢ with i from 2 to 7 of the network protocol stack DSTK, if applicable, the following actions are successively performed:
read the header Hdᵢ of the current layer L₁ within the hard data unit DU₀, store said header Hdᵢ and the header length HdLᵢ into a header length memory HdLBox,
if applicable, also store the header Hdᵢ in a checksum memory CksBox, in view of a further recalculation of the checksum of a lower layer (for a lower layer Lᵢ₋₁ for instance, Hdᵢ belongs to the useful information or payload),
if applicable, extract some information PAD concerning useful information padding bytes and copy it into a specific padding memory PadBox. Said information PAD indicates if some padding bytes are appended at the end of the useful information HUI of the hard data unit DU₀.
read the trailer Trᵢ of the current layer Lᵢ within the hard data unit DU₀, store said trailer Trᵢ and the trailer length TrLᵢ into a trailer length memory TrLBox,
if applicable, extract any other information specific of the protocol of layer Lᵢ.

Note that some of the above-mentioned actions a, b, c, d and e depend on the protocol used. For the UDP protocol, the checksum Cks_{UDP} depends on the useful information or payload HUI and on the headers of upper layers. Therefore, action b needs to be carried out. In the case of the RTP header, a sequence number needs to be extracted. Since soft information is associated with a hard data unit DU₀, the additional data units, which are to be created, will be given the same RTP sequence number. Therefore, action e is compulsory for layer L₄.

Once all the header and trailer sequences have been removed, the discrimination sub-means DISCR are able to calculate the total header length TL using the header lengths HdLᵢ with i from 2 to 7 stored in the header length memory HdLBox and the trailer lengths TrLᵢ with i from 2 to 7 stored in the trailer length memory TrLBox. Since the total header length of the shorter additional information B₀ is N times the total header length THL of the hard data unit DU₀, the knowledge of the total header length THL of the hard data unit DU₀ allows locating the beginning of the shorter useful information UI contained within the shorter additional information B₀. In the same way, since the total trailer length of the buffer B₀ is N times the total trailer length TTL of the hard data unit DU₀, the knowledge of the total trailer length TTL of the hard data unit DU₀ allows locating the end of the shorter useful information UI contained within the buffer B₀. Said useful information UI is output by the discrimination sub-means. The headers Hdi and trailers Tri extracted from said hard data unit DU₀ form the control information HCI also output by the discrimination sub-means DISCR.

It is therefore to be noted that only the hard bits and not the N−1 supplementary soft bits are kept for control information.

The discrimination sub-means DISCR therefore output:
control information CoI, extracted from the hard data unit DU₀,
hard and soft useful information UI contained within said shorter additional information B₀.

Said useful information is then received by the structuring sub-means STRUCT, which are intended to structure said useful information into useful fields.

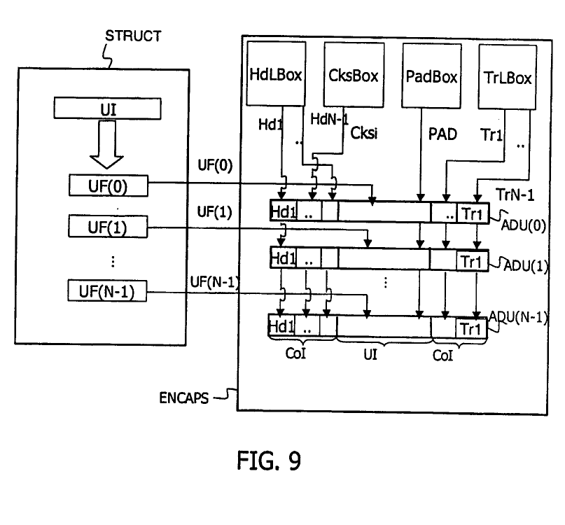

In the adapting means ADAP, the structuring sub-means STRUCT, shown in FIGS. 6a and 9, are then intended to structure said useful information UI into useful fields UF(j) with j from 0 to N−1. A set of N buffers ADU(j) with j from 0 to N−1 is created, whose respective sizes are equal to the one of hard data unit DU₀. In this embodiment of the invention, said useful information UI is divided into N useful fields UF(j) with j from 0 to N−1 in the following way: bit j modulo N from the useful information UI belongs to the useful field UF(j), with j from 0 to N−1.

It is to be noted that said useful information could be divided into another number L of useful fields UF(j), with j from 0 to L−1, L being greater or lower than N.

The formed useful fields UFⱼ are copied into the checksum memory CksBox, where they may be useful to recalculate the checksum of specific layers, for instance in case of the UDP protocol.

In the adapting means ADAP, the encapsulating sub-means ENCAPS, also shown in FIGS. 6a and 9, are then intended to encapsulate said useful fields UF(j) with j from 0 to N−1 into additional data units compliant with the destination network protocol stack DSTK, by using the control information CoI. The buffers ADU(j) with j from 0 to N−1 need to be converted into additional data units and to this end, said encapsulating sub-means ENCAPS successively perform the following actions:
copy the headers Hdᵢ with i from 7 to 2 at the beginning of each buffer ADU(j) with j from 0 to N−1,
copy the N useful fields UFⱼ into their respective buffer ADU(j) with j from 0 to N−1 and complete said buffers ADU(j) with their eventually updated checksums, in order to form as many additional data units ADU(j), that are compliant with network protocol rules. ADU(0) contains the hard bits of the shorter useful information UI, whereas ADU(j) with j from 1 to N−1 contains the j^{th} soft bits of said shorter useful information UI,
copy the trailers Trᵢ with i from 2 to 7 at the end of said useful fields UFⱼ, re-calculate the checksums of concerned layers and copy them into buffers ADU(j) with j from 0 to N−1,
calculate other information specific of the protocols of the layers Lᵢ with i from 7 to 2 and put them at the right place within buffers ADU(j) with j from 0 to N−1.

From this point onwards, said buffers ADU(j) with j from 0 to N−1 have become additional data units. It is to be noted that the hard additional data unit ADU₀ is only an updated version of the original hard data unit HDU₀, whose control information has been recalculated in order to prevent said hard data unit ADU(0) from being further rejected by the destination network protocol stack DSTK of the receiver and the possible routers. This could happen if an error was detected within the hard data unit DU₀.

In this preferred embodiment of the invention, the collecting means COLL are intended to pick up a field within the hard control information CoI supplied by the discrimination sub-means DISCR, which will serve as identifying information for associating an additional data unit ADU(j) with said hard data unit ADU(0) at the second layer. In the first embodiment of the invention, we have mentioned the simple solution of using the RTP sequence number of the associated received source application data unit RASDU as identifying information for the additional data units. The present situation is more complex, because several additional data units ADU(j) are associated with one hard data unit ADU(0). A reordering of the sequence number is therefore needed to ensure that the application layer will process the additional data units ADU(j) in the right order. If we consider the RTP sequence number so of the hard data unit ADU(0), a solution for this embodiment of the invention is to choose the RTP sequence number s₀+j with j from 0 to N−1, as a RTP sequence number for the additional data units ADU(j) comprising the hard and soft information.

Said additional data units ADU(j) are further transmitted to the marking means MARK. Said marking means, for instance, mark them with a specific destination port number P₂, as already mentioned above and output N marked additional soft data units MADU(j), with j from 1 to N−1.

An advantage of using a specific destination port number for said additional data units ADU(j) is that it allows the use of the same RTP sequence number for an additional data unit and a received source application data unit without introducing any confusion at the application layer L₇. As a matter of fact, if we consider for instance two successive hard data units ADU(0) and ADU′(0), with the RTP sequence numbers s₀ and s₀+1 respectively, the first additional soft data unit ADU(1) associated with ADU(0) is also given the RTP sequence number s₀+1. However, it does not raise any problem because ADU(1) is not sent on the same destination port number as ADU′(0). The application layer L₇ is consequently aware of the fact that ADU(1) and ADU′(0) are data of different types, although they have the same RTP sequence number s₀+1.

The additional information ADU(j) is passed upwards through the destination network protocol stack DSTK of the receiver. When it arrives at the application layer L₇ it is received by retrieving means RETRIEV, which are intended to retrieve said additional information, within said marked additional data units MADU(j), that is the useful fields UF(j).

The retrieving means further comprise de-quantification sub-means DEQUANT, for recovering hard information HI and soft information SI from said useful fields UFⱼ.

Said de-quantification sub-means are intended to generate hard and soft information HI and SI from said useful fields UFⱼ with j from 0 to N−1. A de-quantification process is used, which is well known to those skilled in the art. Provided that they have been informed about the kind of quantification used by the quantification sub-means QUANT, the de-quantification means DEQUANT know how many successive useful fields UFⱼ must be processed together. Moreover, they have the same RTP sequence number. When de-quantified, said useful fields form the hard and soft information HI and SI, which is then supplied to the destination application, which is the source decoder in this embodiment of the invention.

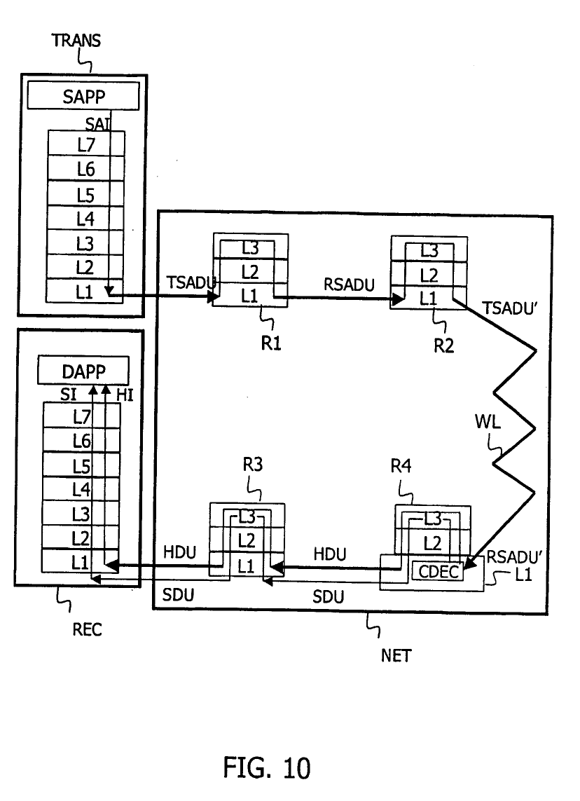

It is to be noted that, as in the previous example, the first (physical) and second (application) layers may both belong to the destination network protocol stack DSTK of the receiver, but it is not limitative. FIG. 10 shows, for instance, a case where the network comprises several routers R₁ to R₄ in charge of routing arriving data units in the right direction. A router is a kind of network protocol stack, which generally uses the three lower layers only. As a matter of fact, only the IP address, which is known up from the network layer L₃, is needed to direct a data unit towards its final target.

In the example of FIG. 10, two types of transmission channels are considered:
internet links between the transmitter TRANS and the router R₁, between the routers R₁ and R₂, between the routers R₄ and R₃, between the router R₃ and the receiver REC,
a wireless link between the routers R₂ and R₄.

A wireless link introduces more noise on data than a wire link. Consequently, it is interesting to use soft decoding at the end of the wireless link, where errors due to transmission noise are the most likely, and to transmit the output soft data on the Internet links to the destination application, in this case a source decoder. In addition to passing through a network protocol stack, the marked additional data units MADU(j) with j from 0 to N−1 have to pass through one or more routers, which should not raise any particular problem, because they are compliant with network protocol rules.

It is to be noted that a soft input-soft output channel decoder CDEC like the one described in the second embodiment is able to output either only hard or both hard and soft outputs.

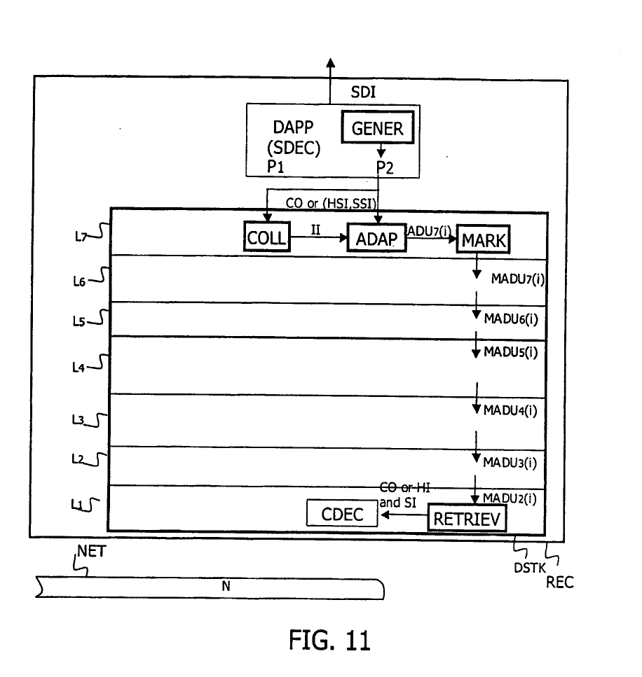

A third embodiment of the invention is described in FIG. 11. It deals with additional information I₃ sent by the application layer L₇ to the physical layer L₁ of the destination network protocol stack DSTK at the receiver side.

Said destination application DAPP therefore comprises generating means GENER for generating a controlling order CO to be addressed to the channel decoder CDEC in order to ask it to do soft decoding. Such a receiver comprises adapting means ADAP and marking means MARK within the application layer L₇ and retrieving means RETRIEV within the physical layer L₁. Said collecting and adapting means are far simpler in this case than in the previous ones, because, when going downwards, this is the network protocol stack, which handles the encapsulation of said controlling order within an additional data unit.

At the level of the physical layer L₁, said retrieving means are on the contrary more complicated than in the previous embodiments. As a matter of fact, such an additional data unit needs to be de-capsulated, when it arrives at its destination, the first layer.

Said retrieving means RETRIEV therefore further comprise de-capsulation sub-means DECAPS, for extracting said controlling order from said additional data unit. Such an operation is performed in the same way as a network protocol stack does.

In this third embodiment of the invention, if the source decoder advantageously decides that hard channel decoded information does not provide an efficient quality of the final source decoded information, said source decoder will consequently ask the physical layer L₁ for additional soft information. To this end, a backward communication is set up between source and channel decoders. Said communication is limited to simple orders like “do hard decoding” or “do soft decoding”. In other words, this embodiment of the invention realizes an “on demand” soft decoding mode.

The advantage of this “on demand” soft decoding mode is that it avoids introducing useless complexity between channel and source decoders. Additional information is only sent when needed by the source decoder.

In a fourth embodiment of the invention, the destination application DAPP is a source decoder SDEC, which provides soft outputs in the same way as the channel decoder CDEC does in the second embodiment. In this case, said source decoder SDEC comprises generating means for generating hard and soft source information HSI and SSI to be addressed to the channel decoder. Said hard and soft source information HSI and SSI follows the same way as the previously described controlling order CO, as shown in FIG. 11. Moreover, said hard and soft source information HSI and SSI is related to a previously received source application data unit RSADU. Consequently, in this fourth embodiment of the invention, the application layer L₇ comprises collecting means COLL, which are in charge of collecting some identifying information II within the application layer L₇ about said previously received source application data unit RSADU. The RTP sequence number RTP_NB can, as before, be taken as relevant identifying information II for associating said hard and soft source information HSI and SSI to said previously received source application data unit RSADU.

Suppose, for instance, that the soft decoding mode is activated. The source decoder SDEC has received hard and soft information HI and SI from the channel decoder CDEC about a received source application data unit RSADU that it uses for generating source decoded information SDI. Like the channel decoder CDEC, the source decoder SDEC also supplies a soft output, i.e. assigns a real value to each data of the received hard and soft information HI and SI. Said real value indicates the decision of the source decoder SDEC and the likelihood of said decision to be exact. In the same way as the channel decoder CDEC, the source decoder SDEC then quantifies said real value over a large number of bits, in order to preserve its precision and supplies source decoded information SDI.

In this case, collecting, adapting and marking means are placed within the application layer L₇, while the retrieving means RETRIEV are placed within the physical layer L₁.

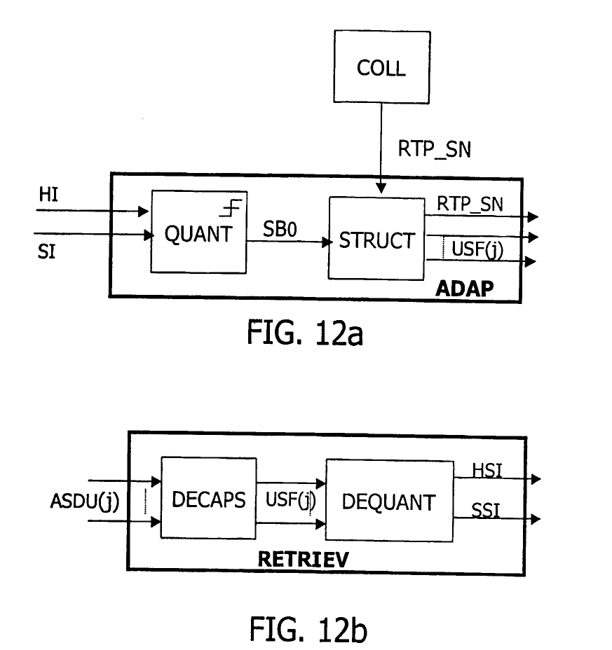

Said adapting means ADAP are described in FIG. 12a and comprise:
quantification sub-means QUANT for supplying shorter source additional information SB₀ from said source additional information HSI and SSI. The quantification is, for instance, made on N bits.
structuring means STRUCT for structuring said shorter source additional information SB₀ into useful source fields USF(j).

Marking means MARK this time aim at indicating to the network protocol stack DSTK that the additional information must be given a specific destination port number P₂, so that the transport layer L₄ correctly fills in the destination port number field within the additional source data units.

At the physical layer, the retrieving means RETRIEV are intended to intercept the additional source data units ASDU(j) with j from 0 to N−1, thanks to their destination port number. Said retrieving means RETRIEV are described in FIG. 12b and comprise:
de-capsulation means DECAPS for extracting useful source fields USF(j) from said additional source decoded data units ASDU(j). Said operation is performed in the same way a network protocol stack does,
de-quantification means DEQUANT for recovering said hard and soft source information HSI and SSI from said useful source fields USF(j).

In this fourth embodiment of the invention, the source decoder SDEC sends back said hard and soft source information HSI and SSI to the channel decoder CDEC.

An advantage of this backward communication between the source decoder SDEC and the channel decoder CDEC is to give feedback to the channel decoder about the way in which the source decoder has processed a received source application data unit RSADU. Using the hard and soft source information HSI and SSI sent by the source decoder, the channel decoder CDEC advantageously re-calculates its own decisions and probabilities about a received source application data unit RSADU and outputs updated hard and soft information. In this way, joint source-channel decoding is performed, which may then iterate in successive passes. The aim of this iterated decoding mode is to make the joint source-channel decoder converge towards the best source decoded information SDI for a given received source application data unit RSADU, in terms of reconstruction quality.

The transmission method described above is preferably implemented by means of sets of instructions, which are executable under the control of computers or digital processors located at the transmitter and at the receiver end.

It is to be noted that, with respect to the described method, receiver, transmitter, transmission system and network, modifications or improvements may be proposed without departing from the scope of the invention. The invention is thus not limited to the examples provided.

Use of the verb “comprise” and its conjugations does not exclude the presence of elements or steps other than those stated in the claim. Use of the article “a” or “an” preceding an element does not exclude the presence of a plurality of such elements.

1. A transmission system for transmitting source application data units to a destination application via a network comprising a plurality of network protocol stacks, characterized in that said transmission system comprises:
generating means for generating additional information at a layer of a first network protocol stack to be sent to a layer of a second network protocol stack via at least said first and second network protocol stacks,
adapting means for converting said additional information into at least an additional data unit compliant with network protocol rules,
marking means for marking said additional data units,
retrieving means for retrieving said additional information within said additional data units when said additional data units arrive at said layer of said second network protocol stack.

2. A transmission system as claimed in claim 1, characterized in that it further comprises:
collecting means for collecting identifying information about a source application data unit, said identifying information being used by said adapting means when converting additional information associated with said source application data unit into at least an additional data unit.

3. A transmission system as claimed in claim 1, wherein a layer of said second network protocol stack comprises acknowledgement means for sending acknowledgement messages about source application data units back to another network protocol stack, characterized in that said transmission system further comprises:
deactivation means for deactivating said acknowledgement means for said additional data units.

4. A transmission system as claimed in claim 2, wherein said additional information is soft information associated with a hard decision made on a source application data unit, characterized in that said transmission system further comprises a channel decoder for supplying said additional information and said adapting means further comprise:
quantification sub-means for supplying shorter additional information from said additional information,
discrimination sub-means for discriminating useful information and control information in said shorter additional information,
structuring sub-means for structuring said useful information into useful fields,
encapsulation sub-means for encapsulating said useful fields into at least one additional data unit compliant with network protocol rules, by using said control information, and said retrieving means further comprise:
de-quantification sub-means for recovering said additional information from said useful fields.

5. A method of transmitting source application data units to a destination application via a network comprising a plurality of network protocol stacks, characterized in that said method further comprises the steps of:
generating additional information at a layer of a first network protocol stack to be sent to a layer of a second network protocol stack via at least said first and second network protocol stacks,
converting said additional information into at least one additional data unit compliant with network protocol rules,
marking said additional data units,
retrieving said additional information within said additional data units when said additional data units arrive at said layer of said second network protocol stack.

6. A method as claimed in claim 5, characterized in that it further comprises the step of:
collecting identifying information about a source application data unit, said identifying information being used in said adapting step when converting additional information associated with said source application data unit into at least one additional data unit.

7. A receiver comprising a destination network protocol stack and a destination application, for processing source application data units transmitted to said destination application via a network comprising another network protocol stack, characterized in that said receiver further comprises:
retrieving means for retrieving additional information generated by a layer of said other network protocol stack and sent to a layer of said destination network protocol stack via at least said other network protocol stack and said destination network protocol stack.

8. A receiver comprising a destination network protocol stack and a destination application for processing source application data units transmitted to said destination application via a network, characterized in that said receiver further comprises:
generating means for generating additional information at a layer of said destination network protocol stack to be sent to a layer of said destination protocol stack via said destination network protocol stack,
adapting means for converting said additional information into at least one additional data unit compliant with network protocol rules,
marking means for marking said additional data units,
retrieving means for retrieving said additional information within said additional data units when said additional data units arrive at said layer of said destination network protocol stack.

9. A receiver as claimed in claim 8, characterized in that it further comprises:
collecting means for collecting identifying information about a source application data unit, said identifying information being used by said adapting means when converting additional information associated with said source application data unit into at least one additional data unit.

10. A receiver as claimed in claim 9, wherein said additional information comprises soft information associated with a hard decision made on a source application data unit, characterized in that said receiver further comprises a channel decoder for supplying said additional information and said adapting means further comprise:
quantification sub-means for supplying shorter additional information from said additional information,
discrimination sub-means for discriminating useful information and control information in said shorter additional information,
structuring sub-means for structuring said useful information into useful fields,
encapsulation sub-means for encapsulating said useful fields into at least one additional data unit compliant with network protocol rules, by using said control information, and said retrieving means further comprise:
de-quantification sub-means for recovering said additional information from said useful fields.

11. A transmitter comprising a source application and a source network protocol stack, for transmitting source application data units to a destination application via a network, characterized in that said transmitter further comprises:
generating means for generating additional information at a layer of said source network protocol stack to be sent via the network to a layer of another network protocol stack, via said source network protocol stack and said other network protocol stack,
adapting means for converting said additional information into at least one additional data unit compliant with network protocol rules,
marking means for marking said additional data units.

12. A transmitter comprising a source application and a source network protocol stack for transmitting source application data units via a network, characterized in that said transmitter further comprises:
generating means for generating additional information at a layer of said source network protocol stack to be sent to another layer of said source network protocol stack,
adapting means for converting said additional information into at least one additional data unit compliant with network protocol rules,
marking means for marking said additional data units,
retrieving means for retrieving said additional information within said additional data units when said additional data units arrive at said other layer.

13. A program comprising a set of instructions for implementing a method as claimed in claim 1, when said program is executed by a processor.
